(19) United States
(12) Patent Application Publication
(10) Pub. No.: US 2004/0173699 A1
(43) Pub. Date: Sep. 9, 2004

(54) Tire recycling system and apparatus used therefor

(76) Inventor: Takao Takasaki, Nichinan-shi (JP)

Correspondence Address: LINIAK, BERENATO & WHITE, Suite 240, 6550 Rock Spring Drive, Bethesda, MD, 20817, US

(21) Appl. No.: 10/378,073

(22) Filed: Mar. 4, 2003

(51) Int. Cl. B02C 19/12

(52) U.S. Cl. 241/65

(57) ABSTRACT

A method of and an apparatus for treating worn tires comprising cutting the circumferential surface of the tire to a predetermined depth by a rotary cylinder having cutting blades each of a rhombic flat plate shape and subsequent separation of metal reinforcement components embedding the tire from the rubber component by RF induction heating that decomposes and carbonizes the rubber portion adjacent with the heated metal components, cutting by the rhombic blades enabling smooth and effective removal of surface tire layer, facilitating the succeeding RF heating and yielding useful cut rubber suitable to obtain variable recycle materials.

### BACKGROUND THE INVENTION

1. Field of the Invention

The present invention concerns a tire recycling system and apparatus used therefor and, more in particular, it relates to a method of treating and recycling worn tires and further re-utilizing the tire rubber portions as various useful materials, as well as apparatus used therefor.

2. Statement of the Related Art

Methods of recycling worn tires include two types of re-grooving the tread surface of the tires and utilizing them again as retread tires and a method of cutting and decomposing worn tires entirely to recover rubber portions and metal portions respectively as valuable materials.

For the re-grooving method of worn tires, various methods of grinding or buffing the worn surface of tire treads by using rasp blades have been adopted, for example, as proposed in WO97/06002. However, in the rasp method, the temperature at the top end of the rasp is increased by heavy cutting load during grinding operation to cause remarkable abrasion of rasp and the lapse blade has to be exchanged frequently. For example, when the rasp method is adopted for the re-grooving of air plane tires, and the tread surface is ground to a depth of 7 to 10 mm, the rasp blade is abraded after fabrication of only several tires to need replacement.

For improving the drawback of the rasp method, Japanese Patent Laid-Open No. 223273/1995 proposed a surface layer grinding tool in which a sintered diamond member is welded to a blade. Further, in this improved rasp, an air vent hole is formed for removing the heat generated by grinding. However, while the durability of the rasp is increased, since the cutting width of the individual blade is large, it results in increase of the cutting load and, in addition, the structure is mode complicated and fragile by the provision of the air cooling mechanism.

In the tire retreading system, a peeling system of using a cylindrical grinding blade for cutting a shoulder part of the tread rubber before rasp grinding has also been used. This method is advantageous in view of the life of the cutting tool. However, cutting of rubber material with the blade is also difficult and cutting speed can not be increased so much because of the worry of causing frictional smoking during cutting. In addition, the cut rubber pieces discharged from the cylindrical blade forms continuous long strings which are difficult to be handled in the subsequent recovery steps.

As described above, treating of worn tires by the grinding tool suffers from large cutting load and heat generation to lower the cutting efficiency and require frequent replacement of cutting tools. Accordingly, the approach for re-utilizing the worn tires by the retreading method is restricted only to particular applications such as recapping of aircraft tires, and this method can not be generally applied to usual tires, for example, of automobiles and the likes which are discarded in a great amount.

Accordingly, for the recycling use of general automobile tires, etc., disposal of entire tires by cutting or crushing and recycle use of waste rubber materials are considered more practical and advantageous over the retreating method. However, in the crushing and pulverization of tires, metal portions such as steel cords (belts) or steel beads are incorporated as reinforcements in the tire rubber portion. Cutting of tires incorporating steel materials by cutting tools is difficult and damages cutting blades. Then, methods of crushing or pulverizing tires by utilizing a cryogenic technique has been proposed. That is, worn tires are immersed in cryogenic liquid nitrogen to render the rubber harder and more fragile so that they can be crushed by impact more easily (for example, in Japanese Patent Laid-Open Nos. 156225/1999 and 207742/1999). However, treatment of a large amount of worn tires with a cryogenic facility requires an enormous cost. In addition since crushed products contain metal components, they have to be separated before re-using the rubber portions.

Then, in order to previously separate metal components from the tire rubber portion, methods of applying radio frequency (RF) induction heating to the circumferential surface of tires have been proposed (for example, in Japanese Patent Laid-Open Nos. 121977/1994 and 370227/2002). Radio frequency power applied from the circumferential surface to the inside of the tire causes induction heating to the metal components (such as steel cords, steel beads) buried deep inside of the rubber to thermally decompose and carbonize the rubber material near the metal components and they can be easily peeled from each other.

However, since the RF power is applied from the outermost circumferential surface of the tire through the considerable thickness of the rubber material to the metal components inside the tire, it requires a large amount of electric power with large induction loss. Particularly, the tire tread portion constitutes a most portion of the tire and contains steel cords (belts) at the deep inside, so that they require large RF power. In addition, if the rubber and metal components are separated by the RF induction heating, drawing out of the metal components from the deep inside of the tire tread portion is difficult and troublesome.

As has been described above, the existent tire recycling system by retreading involves difficulties in that no suitable cutting or grinding tools to tire rubber material are available, which makes the application difficult to usual tires such as automobile tires. In addition, cryogenic method or RF induction method as another approach to the tire recycling system also involves respective difficulties and drawbacks. Then, most of worn tires are obliged to be discarded as they are or only subjected to burning treatment, which result in serious environmental problems.

### SUMMARY OF THE INVENTION

The present invention intends to provide a tire recycling method and apparatus used therefor capable of simply and rapidly treating waste tires at reduced energy and cost and capable of obtaining cut rubber pieces which can be reused as useful rubber materials.

The present inventor has found that a rotary cylinder having plural cutting blades each of a specific tetragonal or rhombic plate shape already disclosed by the present inventor, for example, in U.S. Pat. No. 4,747,522 for food processing use is actually effective for cutting the tire rubber and, by combining the use of such rhombic plate blades with the RF induction heating process, worn tires can be actually treated effectively and unexpectedly and cut rubber pieces have useful property and shape for recycling use.

That is, the foregoing subject of the present invention can be attained in one feature of the invention by a method of treating worn tires comprising;

a step of rotating a worn tire and a rotary cylinder each around its axis such that cutting blades arranged on the circumferential surface of the rotary cylinder bite into the tread surface of the worn tire, each of the cutting blades having a tetragonal or rhombic flat plate shape and attached substantially in parallel with the circumferential surface of the rotary cylinder,

a step of cutting the tread portion of the tire to a predetermined depth,

a step of radiating a radio frequency power to metal components embedded in the tire rubber portion thereby a heating the metal components by induction heating and, at the same time, decomposing and carbonizing rubber portions adjacent with the heated metal components, and

a step of separating the metal components from the rubber portion and drawing the metal components out of the tire.

Since the cutting blade of the rhombic plate-shape can sharply cut the rubber material with low cutting load, the tread surface can be cut smoothly at high speed with no heat generation and with no damages for the cutting blade. Then the RF power is applied from the outer circumference of the tire, transmitted to the metal components and causes induction heating therein. The metal components are heated and the heat decomposes and carbonizes the rubber portion adjacent with the metal components into an easily peelable state. Since the tread portion has been already cut to a place at or near the metal components, the RF power can be effectively transmitted to the metal components with less induction loss. Then, the metal components can be easily separated and drawn out of the tire through the already cut portion.

The rubber pieces after the cutting are in the uniform shape of fine short string of 1 to 2 mm square and 5 to 10 mm. Such uniform size of fine rubber strings are easy to handle with and useful for recycling use.

Another feature of the invention, further includes a step of cutting the rubber portion after separating of the metal components into individual strands of an appropriate size and a step of successively feeding them to the rotary cutting area of the rotary cylinder thereby cutting them into fine rubber pieces.

In this case, the rubber portion after removing the metal components are cut into short strands and fed successively to the rotary cylinder described above and then cut in the same manner.

An apparatus for treating the worn tire used for the method described above comprises;

a device for rotating a worn tire around its axis,

a rotary cylinder rotating at a high speed around its axis having plural of bar holders and plural cutting blades arranged to each bar holder,

each of the bar holders extending along the length of the rotary cylinder and spaced apart from each other by an equal circumferential length,

the plural cutting blades being arranged on each of the bar holders at a predetermined pitch,

each of the cutting blades has a tetragonal or rhombic flat plate shape including a top cutting edge at the top end at an acute angle in the rotating direction formed between a pair of side cutting edges extending from the top end along both rhombic sides,

a cover covering the entire circumference of the rotary cylinder except for an open portion to expose a portion of the rotary cylinder and having a recovery box in contiguous with a duct,

a sensor for detecting that the cutting depth of the tread surface by the cutting blade arrives at or near the uppermost surface of the metal components and stopping the rotation of the rotary cylinder.

In the apparatus, the thread portion of the tire can be substantially cut by the rotary cylinder and the cut pieces obtained thereby can be utilized to the duct as useful rubber materials.

Since the rotary cylinder has a plurality of bar holders attached to the circumferential surface, and a plurality of cutting blades are combined and secured to each bar holder at a determined pitch, the cutting blades can be secured fixedly to the rotary cylinder. Further, when one of the cutting blades should be broken or abraded to require replacement, it is replaced together with the bar holder for a spare bar holder. Accordingly, the replacing operation is simple and maintenance operation can be done quickly.

The apparatus also preferably includes a radio frequency power induction heating device to be located for the radial circumference of the tire for radiating radio frequency power to the metal components embedded in the tire thereby heating the metal components and decomposing and carbonizing the rubber portion adjacent therewith.

Since the tread rubber has already been cut and removed by the cutting of the rubbery cylinder, the RF power effectively actuates on the steel cords and, further, the separated steel cords can be easily withdrawn through the cut portion in the tread surface.

The apparatus also preferably includes a device for cutting rubber pieces obtained after removing-metal components by RF induction heating, the device including a conveyor for successively feeding the rubber pieces to a receptacle plate and a retainer for retaining and urging the pieces against the cutting blades of the rotary cylinder.

The remaining rubber portion after removing the metal components can be cut effectively in the manner similar with that described above.

### DESCRIPTION OF THE ACCOMPANYING DRAWINGS

A preferred embodiment of this invention will be described in details based on the drawings, wherein

FIG. 1 is a schematic front elevational view of a device for a rotary cylinder for cutting a tire rubber;

FIG. 2 is a left side elevational view of the device;

FIG. 3 is a perspectaive view f a cutting blade;

FIG. 4 is a side elevational view showing the state of attaching a cutting blade to a bar holder;

FIG. 5 is a perspective view of a bar holder attached with cutting blades;

FIG. 6 a schematic view for the cutting operation of a tire tread portion by the rotary cylinder shown in FIG. 1;

FIG. 7 is a schematic view showing an operation of applying RF induction heating to the tire after cutting the tread portion;

FIG. 8 is a schematic cross sectional view of an RF induction heating device located around a tire;

FIG. 9 is a view for explaining the cutting operation for rubber pieces after RF induction heating process; and

FIG. 10 is a pattern showing the arrangement of the cutting blades.

### PREFERRED EMBODIMENT OF THE INVENTION

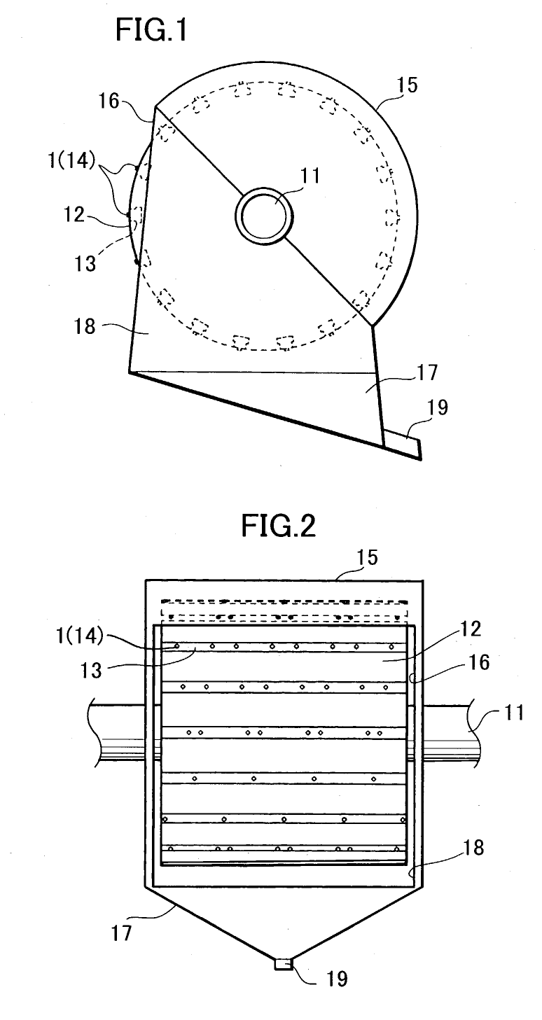

A preferred embodiment of the present invention is to be described with reference to the drawings. As shown in FIG. 1 and FIG. 2, a worn tire cutting device has a rotary cylinder 12 having a plurality of cutting blades 1 to cut a surface tread rubber layer of a tire rotated by a tire rotating device to be described below and a cutting dust recovery box 17.

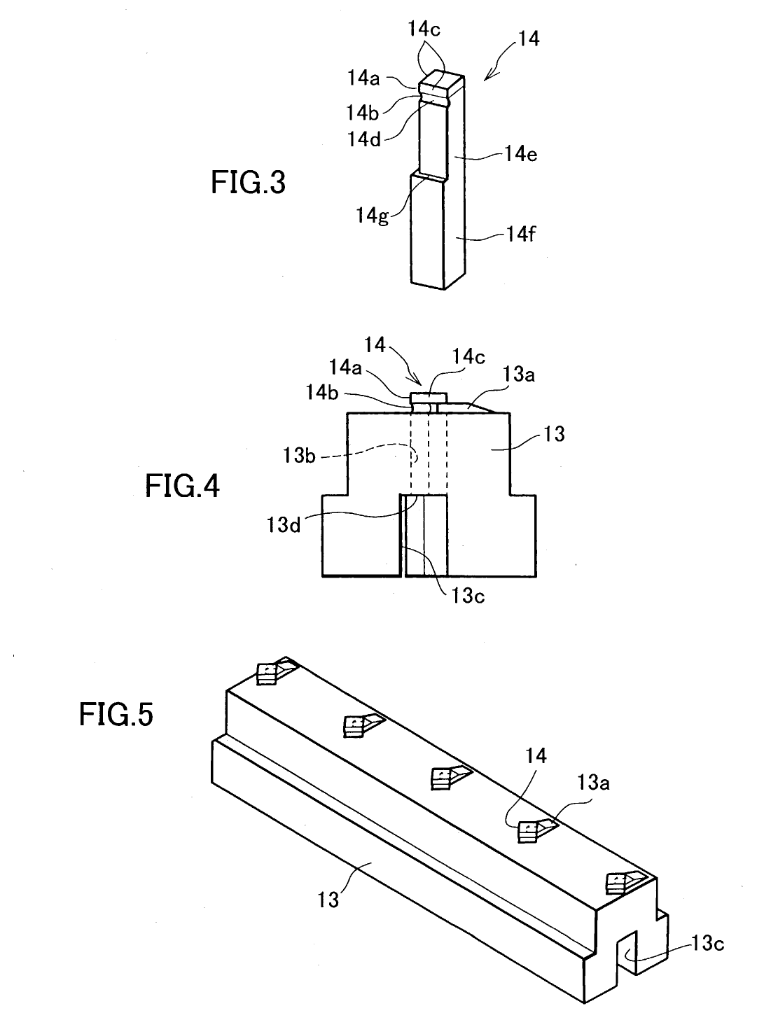

The cutting blade 1 is, more specifically, constituted as a cutting blade 14 as shown in FIG. 3. The basic structure of the blade 14 has already been disclosed by the inventor, for example, in U.S. Pat. Nos. 4,747,552 and 4,779,811 and a modified and detailed structure and an attaching mechanism thereof are closely described also by the inventor in Japanese Patent Laid-Open No. 136041/1997. The blade 14 has a flat rhombic plate shape including a top cutting edge 14a formed at a top end of the rhombic plate in the rotational direction of the rotary cylinder 12 and a pair of right and left side cutting edges 14c and 14c extending from the top end along both rhombic sides so as to form a substantially V-shaped configuration. In addition, the portion in adjacent and below the top cutting edge 14a forms a front cutting edge 14b.

Then, a blade post 14e of a rhombic cross section is in vertically contiguous with the lower portion of the flat rhombic plate by way of a concave grooves 14d. The blade post 14e is in contiguous with a lower base post 14f of a larger cross section with a step being formed therebetween as a shoulder 14g.

As shown in FIGS. 4 and 5, a bar holder 13 of a substantially square cross sectional shape has a plurality of engaging grooves 13c along the longitudinal direction thereof each at an appropriate distance. Each of the engaging grooves 13c is formed as an independent perforation hole perforating vertically and a shoulder 13d constituting a step is formed at the midway of the hole.

As shown in FIG. 4, the engaging groove 13c is formed such that when the blade 14 is inserted from the lower portion of the engaging groove 13c, the shoulder 14g abuts against the shoulder 13d of the groove and such that the portion of the blade including the top cutting edge 14a, the front cutting edge 14b, and the side cutting edge 14c, and arcuate groove 14d therebelow are exposed above the upper surface of the bar holder 13.

By the provision of the shoulder 14g and the shoulder 13d abutting against each other, the height for each of the blades when attached and exposed to the circumferential surface of the cylinder can be made uniform easily and the operation for assembling the blade 14 can also be facilitated.

A support 13a that supports the blade 14 exposed above the surface of the bar holder 13 at the back may be optionally provided on the surface of the bar holder 13. The blade 14 and the optional support 13a are secured to the bar holder 13 by means of brazing.

Plural bar holders 13 each having a plurality of blades 14 attached thereto are mounted to the circumferential surface of the rotary cylinder 12 that rotates around a rotary shaft 11 so as to be in parallel with the rotary shaft 11 as shown in FIG. 1 and FIG. 2. As shown in FIG. 2, the cutting blades 14 secured to bar holders 13 are positioned such that they are displaced by a certain distance from each other in the axial direction of the rotary cylinder 12. This arrangement of the blades 14 enables uniform cutting for the surface tread portion of the tire along the direction of the tire width as will be described below.

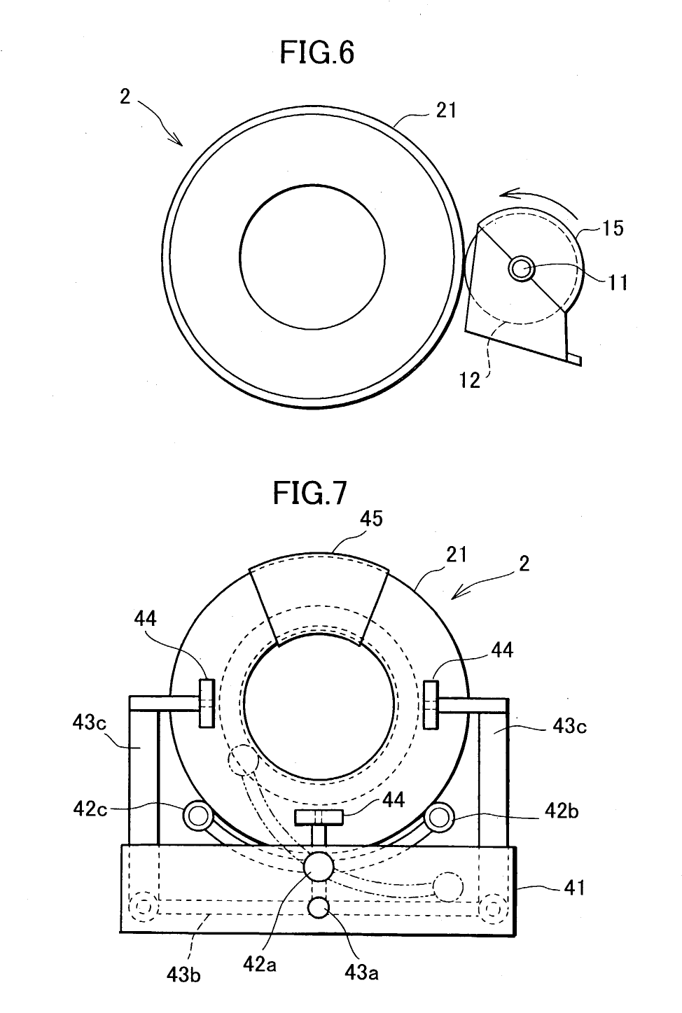

The rotary cylinder 12 having a plurality of rotary blades 14 is housed in a cover 15 which is formed in an arcuate shape so as to be along the circumferential surface of the rotary cylinder 12. A recovery box 17 having a slanted bottom is attached to the lower portion of the cover 15 and has an opening 16 for exposing a portion of the rotary cylinder 12. In the recovery box 17, a slanted receptacle 18 defining the opening 16 is formed and a duct attaching port 19 is disposed by way of the slanted bottom from the slanted receptacle 18. As schematically shown in FIG. 6 a device for slowly rotating the tire 2 is located at the left of the rotary cylinder 12 shown in FIG. 1 such that the circumferential surface of the tire tread portion 21 is in contact with and cut by the cutting blades on the rotary cylinder 12. The device is made accessible to the rotary cylinder along with the cutting process by the rotary blades.

FIG. 6 schematically show the method of cutting a tire surface rubber (tread surface) 21 by using the tire rubber cutting device as described above. When the rotational cylinder 12 is rotated at a high speed and the rotary blades 1(14) thereof abut against the tire 2 under slow rotation, the surface tread rubber 21 of the tire 2 is cut into a V-shape by each top cutting edge 14a and a pair of side cutting edges 14c and 14c. In this case, the cut rubber string is disconnected by the front cutting edge 14b into a fine short string (for example, 0.5 to 1.0 mmφ and 5 to 10 mm length) in this case. The effective cutting width is determined by the rhombic diameter but since the cutting impact is at first exerted on the sharp top cutting edge 14a and then dispersed gradually to right and left side cutting edges 14c and 14c, the rubber can be cut sharply with less impact and frictional resistance and thus no cooling or air vent means is necessary. Further, as apparent from the planar shape of the blade, it is stable and resistant to impact shock and the blade has no requirement for exchange during long time use. The cut rubber in the form of fine short string is discharged by a centrifugal force from the inclined receptacle 18 by way of the inclined bottom to the duct attaching port 19 and then fed to an optional duct.

The thus obtained rubber pieces can be re-utilized as various application uses such as fuels and pavement materials. Particularly, in a case of using the rubber pieces for the components of the pavement material, since the rubber pieces have uniform appropriate dimension as described above, it can be easily compounded with other pavement materials, while retaining their elastomeric property as they are. Thus this fine short string rubber is useful as the pavement material for play grounds and high way roads which require anti-slip function and somewhat elastomeric filling that can not be obtained by granulated rubber powder.

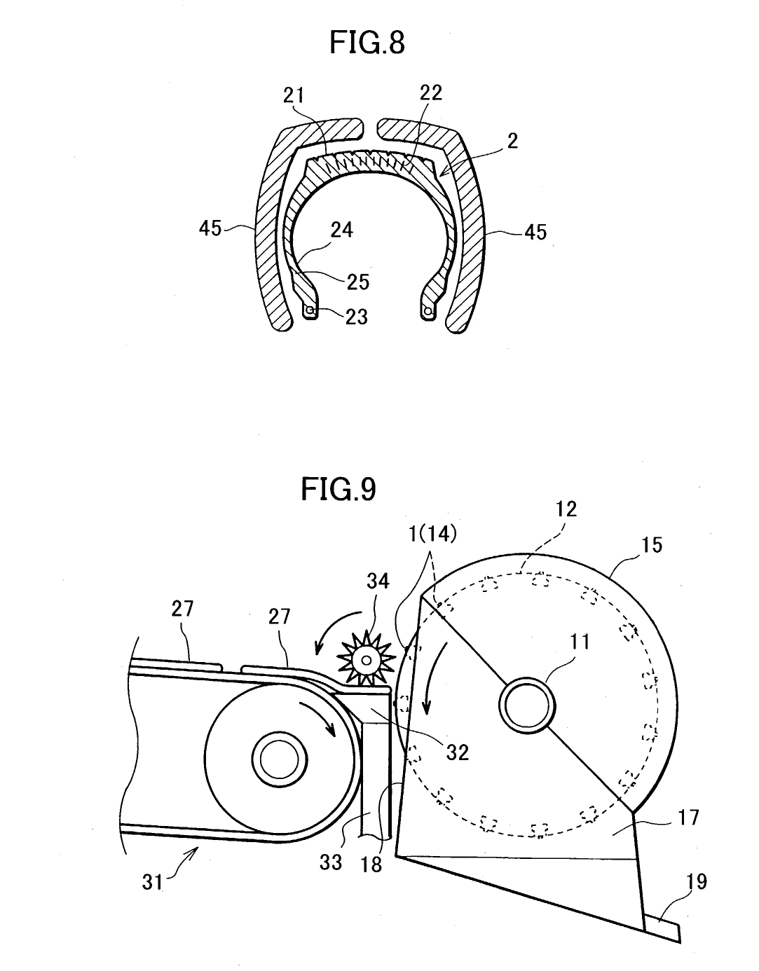

Then, separation of metal components from the rubber portion in the tire 2 is to be described with reference to FIGS. 7 and 8.

FIG. 7 is a schematic view for applying RF induction heating to a tire. A tire supporting base 42 has a rotational shaft 42a, and right and left rotational rolls 42b and 42c are swingeably attached integrally around the rotational shaft 42a as a center. Further a slide shaft 43a is disposed to the base 41 and sliders 43b are extended right and left so as to interlock with the slide shaft 43a. Arms 43c are vertically disposed rotationally on right and left ends of the sliders 43b. A retainer roll 44 is attached to the upper end of each arm 43c, and also to the slide shaft 43a.

The tire 2 from which the tire tread rubber 21 has been cut by the rotary cylinder 12 is placed on the base 41, for example, in a state of lowering the rotational roll 42b on the right. Then, the roll 42b on the right is raised again and the rotational rolls 42b and 42c are abutted against the lower part of the surface layer of the tires. In this state, the tire 2 is retained by each of the retaining rolls 44.

Then, an RF induction heating coil device 45 is located around the radial outer circumference of the tire such that it is close to the surface layer 21 of the tire 2 as also shown in the cross section of FIG. 8.

Then, the RF induction heating coil 45 is actuated to apply RF power (for example, about 100 KHz, 10 KW) to the metal components such as steel cords (belt) 22 exposed on the surface of the tire and steel bead cores 23 during at least one rotation of the tire 2 by the rotational driving of the rotational roll 42b and 42c. Thus, RF power causes induction heating in the metal components to generate heat and decompose and carbonize the rubber portions adjacent with the metal components thereby making the metal components easily peelable from the adjacent rubber portions. Then, the steel cords 22 at the tread portion are peeled easily. Further, since the metal bead cores 23 are also made peelable by the induction heating, a carcass ply 24 is cut out and then the bead cores 23 are withdrawn through the cut out portion 25.

Again, referring to FIG. 7, the rotational roll 42c is lowered and the tire 2 is taken out of the base 42. The tire 2 is divided by a known cutting tool into individual short strands. When the rubber is divided by the cutting tool, since metal components have already been removed, cutting can be made easily with no injury to the blades of the cutting tool and any appropriate cutting tool may be used.

Then, as shown in FIG. 9, the thus obtained rubber strands 27 are conveyed successively on a conveyor 31 and sent to a receptacle plate 32 on a receptacle stand 33. A retaining gear 34 is located above the receptacle plate 32. The rubber strand 27 is conveyed while being engaged and urged to the receptacle plate 32 by the teeth of the gear 34 and cut by the same cutting blades 1(14) identical with that shown in FIG. 1. In this case, the strand is cut into granular rubber pieces and then discharged centrifugally from the slanted receptacle 18 to the duct attaching port 19. The granular rubber dust can also be used for various rubber materials such as fuels and other materials.

### WORKING EXAMPLE

Various kinds of waste tires were treated by the apparatus of the present invention described above.

A rotary cylinder 12 of 164 mm in diameter and 98 mm in cutting width (cylinder length) having a plurality of cutting blades 14 on the circumferential surface was used.

The cutting blade 14 used included three types, having a blade diameter (rhombic diameter) of 1.4 mm, 2.38 mm, and 3.5 mm: a blade height of 1 mm, 1.5 mm and 2 mm and a thickness of the top cutting edge and side cutting edge of 0.3 mm, 0.4 mm, and 0.5 mm. Cutting was conducted at a normal temperature with no countermeasure for heat generation under a rotating speed of the rotary cylinder at 2000 rpm. There was neither heat generation for the blade nor smoking from the rubber and the surface rubber could be cut into fine short rubber strings.

Further, when the apparatus was used for the cutting of rubber crawler for use in caterpillars which are extremely hard and have been considered so far not possible to be cut by any blade. When the rotary blade 14 of 3.5 mm blade width, 2 mm blade height and 0.5 mm edge thickness was used, and rubber crawler cut into 30 mm width and 30 mm height was cut under a normal temperature in the summer season with no air cooling countermeasure. Also in this case, fine short rubber strings could be recovered with no heat generation and smoking. It was confirmed that for cutting the rubber crawler, smaller rubber blade width and edge thickness is more preferred.

Since even the hard caterpillar rubber crawler could be cut sharply with no troubles, it is considered that the apparatus of the invention can be applied also for the re-grooving of the air plane tires with higher efficiency and lower cost compared with existent rasp blade or other grinding tool.

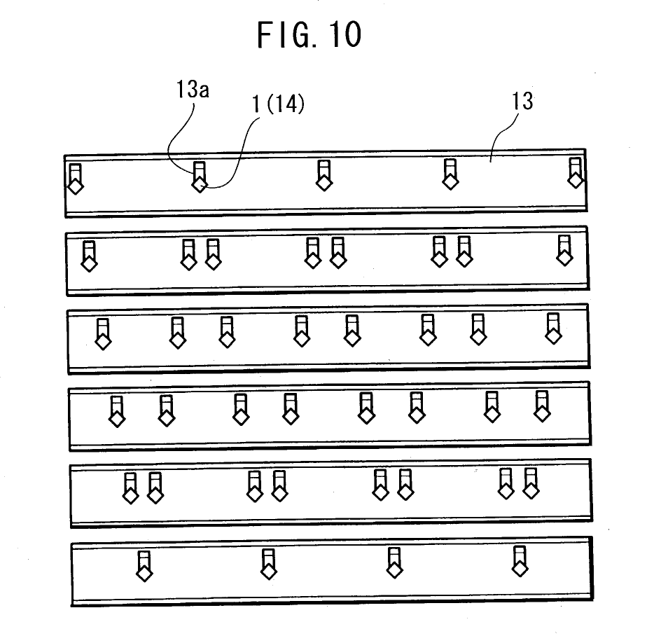

In this working example, as shown in, FIG. 10, cutting blades 1(14) arranged on each of the bar holders 13 were positioned along the length of the holder 13 such that they were gradually displaced each by a predetermined pitch while being overlapped by about 0.14 mm to 0.5 mm between each of the succeeding bar holders so that they were uniformly distributed, as a whole, along the direction of the cutting width (cylinder length) of the rotary cylinder. The size of the fine rubber string can be adjusted depending on the blade width, the blade height of the cutting blade 14 and the diameter of the rotary cylinder 12. This arrangement of the cutting blades enables effective cutting of the tire tread uniformly.

According to the present invention, since the cutting blades used for the cutting of the rubber undergoes less cutting load on the blade due to its rhombic shape, it can be used effectively for the cutting of tire rubber with no heat generation at a normal temperature and with less frequency for exchanging the blade. This feature of the sharp cutting rhombic blade can be further combined advantageously with the RF induction heating technique of separating the rubber component from the metal component thereby facilitating the process for treating waste tires. In addition, since the cutting dusts obtained by cutting the rubber by the rhombic blades are in the form of fine short string, it can used particularly effectively for pavement materials and the like.

What is claimed is:

1. A method of treating worn tires comprising;
a step of rotating a worn tire around its axis and rotating a rotary cylinder at a high speed around its axis such that cutting blades arranged on the circumferential surface of the rotary cylinder bite into the tread surface of the worn tire, each of the cutting blades having a tetragonal or rhombic flat plate shape including a top cutting edge at the top end in the rotating direction and a pair of side cutting edges extending from the top end along both rhombic sides;
a step of detecting that cutting in the tread portion of the tire reaches a predetermined depth and stopping the rotation of the tire and the rotary cylinder;
a step of locating a radio frequency induction heating device at a position of the tire around an outer radial circumference thereof including the already cut tread portion, and radiating radio frequency power to the metal components embedded in the tire rubber portion while slowly rotating the tire thereby heating the metal components by induction heating and, at the same time, decomposing and carbonizing rubber portions adjacent with the heated metal components; and
a step of separating the metal components from the rubber portion and drawing the metal components out of the tire.

2. A method of treating worn tires according to claim 1, which further includes a step of cutting the rubber portion after separating of the metal components into individual strands of an appropriate size and a step of successively feeding them to the rotary cutting area of the rotary cylinder thereby cutting them into fine rubber pieces.

3. An apparatus for treating the worn tire used for the method described in claim 1 comprising;
a device for rotating a worn tire around its axis;
a rotary cylinder rotating at a high speed around its axis and having plural bar holders buried in the circumferential surface of the rotary cylinder and plural cutting blades arranged to each of the bar holders,
each of the bar holders extending in parallel with the axis of the rotary cylinder and spaced apart from each other by an equal circumferential length of the rotary cylinder,
the plural cutting blades being arranged on each of the bar holders each at a predetermined pitch,
each of the cutting blades having a tetragonal or rhombic flat plate shape including a top cutting edge at the top end in the rotating direction and a pair of side cutting edges extending from the top end along both rhombic sides;
a cover covering the entire circumference of the rotary cylinder except for an open portion to expose a portion of the rotary cylinder and having a recovery box in contiguous with the cover and leading to the duct; and
a sensor for detecting that the cutting depth of the tread surface by the cutting blade arrives at or near the uppermost surface of metal components embedded in the tire and stopping the rotation of the tire and the rotary cylinder.

4. An apparatus according to claim 3, further including a radio frequency power induction heating device to be located for the radial circumference of the tire for radiating radio frequency power to the metal components embedded in the tire thereby heating the metal components and decomposing and carbonizing the rubber portion adjacent therewith.

5. An apparatus according to claim 4, which further includes a device for cutting rubber pieces obtained after separation of the metal components by RF induction heating, the device including a conveyor for successively feeding the rubber pieces to a receptacle plate and a retainer for retaining and urging the pieces against the cutting blades of the rotary cylinder.
